(19) United States
(12) Patent Application Publication
(10) Pub. No.: US 2017/0374423 A1
(43) Pub. Date: Dec. 28, 2017

(54) CROWD-SOURCED MEDIA PLAYBACK ADJUSTMENT

(71) Applicant: Glen J. Anderson, Beaverton, OR (US)

(72) Inventor: Glen J. Anderson, Beaverton, OR (US)

(21) Appl. No.: 15/192,106

(22) Filed: Jun. 24, 2016

(51) Int. Cl. H04N 21/466; H04N 21/488; H04N 21/458; H04N 21/45; H04N 21/442; H04N 21/4402; H04N 21/44; H04N 21/439; H04N 21/6543; H04N 21/435

(52) U.S. Cl. CPC H04N 21/4667; H04N 21/6543; H04N 21/4884; H04N 21/4661; H04N 21/458; H04N 21/435; H04N 21/442; H04N 21/44029; H04N 21/44008; H04N 21/439; H04N 21/4532

(57) ABSTRACT

Various systems and methods for providing crowd-sourced media playback adjustment are provided herein. A media playback system for adjusting media playback includes a user profile manager to access a user profile database to obtain a user profile associated with a user of the media playback system, the media playback system to present a media presentation; a media processor to analyze the media presentation to obtain metadata embedded in the media presentation; a transceiver to receive a media enhancement command at the media playback system; a multimedia compiler communicatively coupled to the transceiver, to alter the media presentation in response to the media enhancement command, to produce an altered presentation of the media presentation, the alteration based on the media enhancement command, the metadata, and the user profile; and a display communicatively coupled to the multimedia compiler, to present the altered presentation to the user on the display.

### TECHNICAL FIELD

Embodiments described herein generally relate to media playback apparatus and in particular, to crowd-sourced media playback adjustment.

### BACKGROUND

Media players may be used in a variety of situations and environments to provide news, entertainment, and other information to users. In some situations, a user may not be able to comprehend portions of a media playback due to ambient noise, low-quality soundtrack, or other issues. In such situations the user may miss key information, such as a plot point, dialog, or a news briefing.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating data and control flow of a media system, according to an embodiment;

FIG. 2 is a schematic diagram illustrating data and control flow, according to an embodiment;

FIG. 3 is a block diagram illustrating a system for adjusting media playback, according to an embodiment;

FIG. 4 is a flowchart illustrating a method of adjusting media playback, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

While watching or otherwise consuming media playback, a user may be distracted or unable to ascertain various audio portions. When the audio portion include dialog, news bites, or other spoken phrases, the user may be inconvenienced by having to rewind the media playback, turn up the volume, repeatedly view or listen to the same portion multiple times, or ask another member of the audience to relay what was missed. What is needed is a more intelligent media playback system that accommodates a user according to various factors.

Systems and methods described herein implement a crowd-sourced media playback adjustment. A media presentation may be adjusted automatically based on environmental factors, histories of previous viewings, user personalization, and media attributes. Aspects of the presentation may be shared in a community of users so that playback for a user may be modified based on the playback experience of a different user or subset of users. In particular, the media presentation may be adjusted, augmented, or otherwise altered to provide a user with additional information so that the user is able to understand the story, dialog, or other aspects of the media presentation.

Closed captioning and the use of subtitles are each ways of displaying text on a screen to provide additional or interpretive information. Each are typically used to provide transcription of the audio portion of the presentation as it occurs. Closed captioning is often used during broadcasts and created in or near real time, to illustrate what was said, what noises occurred, or other aspects of the presentation. Subtitles may be created and packaged with the presentation, optionally enabled by the viewer, and are often more accurate than closed captioning due to their pre-edited nature.

While some countries do not distinguish between closed captioning and subtitles, in this discussion closed captioning will be used to refer to a mechanism (primarily for the deaf or hard of hearing) to describe both the dialog and the events, such as off screen events, in a presentation. In contrast, subtitles will be used to refer to transcription services that provide an on-screen text for dialog, which may be a translation from another language or may be used to clarify the audible portions of the presentation (e.g., clarify subdued speech, a thick accent, or mumbling).

In various embodiments, in addition to or in the alternative of using subtitles or captioning, one or more aspects of the video portion of a presentation may be adjusted, augmented, or otherwise altered to assist viewing. For example, in a dim scene, the brightness, contrast, or other video adjustments may be made to accommodate viewing.

Either video or audio adjustments and enhancements may be provided based on various contextual cues, such as ambient noise, ambient light, crowd-sourced data, user feedback, or the like. For example, when the user/viewer misses a portion of the presentation and rewinds it, the presentation may be automatically augmented with closed captioning or subtitles in the replayed portion, and then disable the closed captioning or subtitles after the replayed portion is complete. In this manner, the user/viewer is more likely to comprehend the dialog of the rewound portion. Other mechanisms are described throughout this document.

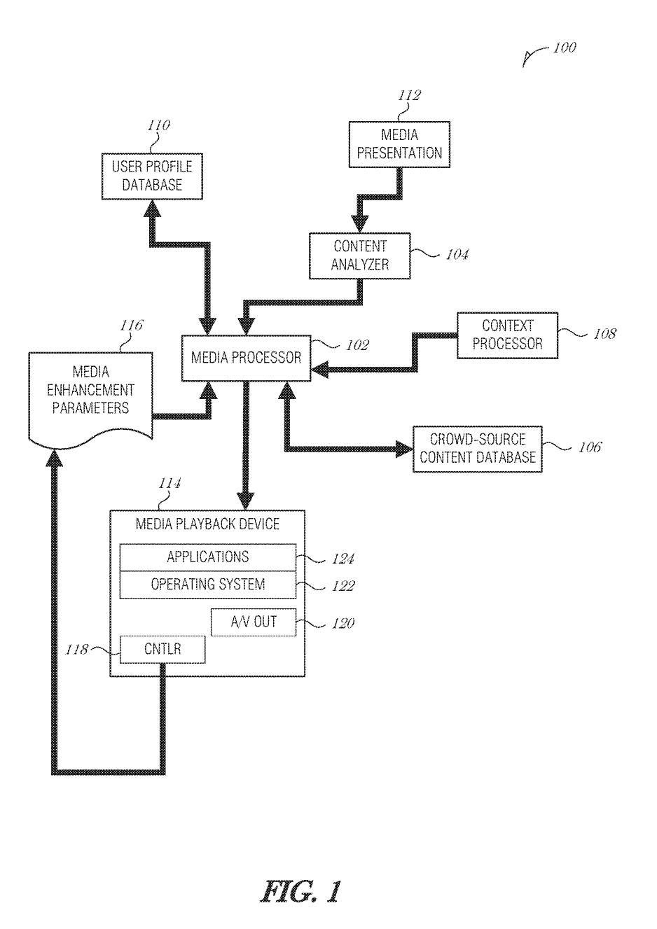

FIG. 1 is a block diagram illustrating data and control flow of a media system 100, according to an embodiment. A media processor 102 receives input from a variety of sources, including a content analyzer 104, a crowd-sourced content database 106, a context processor 108, and a user profile database 110. The media processor 102 uses the input from the various input sources (e.g., user profile database 110, content analyzer 104, or crowd-sourced content database 106) and modifies an audiovisual presentation 112, which is then output on a media player 114.

The media processor 102 may be incorporated into the media player 114 or may be separate (e.g., at a streaming or broadcast server). The media player 114 may be any type of device capable of presenting audiovisual presentations including, but not limited to, a Blu-ray (BD) player, a digital versatile disc (DVD) player, a television, a laptop, a desktop computer, a tablet, a smartphone, or the like.

The user profile database 110 stores profiles of users that have provided information to the user profile database 110. The users may be local users or universal users. Local users include those people that have used the media player 114. Such users may provide information that is specific to the environment where the media player 114 is situated, such as in a living room, bedroom, office, etc. Universal users are those that have used media processor 102 service, for example, in the case of server-based media processing. Universal user profiles may include location information so that the user's profile may be adjusted based on where the user is viewing content.

A user profile may include information including the user's name, gender, age, native language, other languages the user is conversant in, view locations, hearing metrics, vision metrics, and other user preferences. A user may actively set up a user profile. For example, the user may register with the user profile database 110 by providing a username-password combination. The user may then provide user information e.g., hearing or vision metrics) other user preferences.

Hearing metrics may include an indication of hearing loss or other hearing impairments. The user may provide sound frequencies that are difficult for the user to hear. The user may interact with the media player 114 or other components of the system illustrated in FIG. 1 to conduct an impromptu hearing test, which may then be used to set thresholds of an upper and lower frequency that the user is capable of hearing. Such an evaluation data may be from a patient record from the user's doctor, or by a contemporaneous evaluation performed by a computing device (e.g., media player 114) where the device may test the user by playing tones for the user at various amplitudes to detect volume and pitch issues.

Vision metrics may similarly provide an indication of visual impairments or other preferences with respect to visual preferences of the user. Visual impairments such as color blindness, near or far sightedness, night blindness, or other impairments. Users with vision issues may be compensated for by temporarily or permanently increasing contrast, brightness, or color schemes in presentation to accommodate the user.

User information may include preferences. Preferences may include language preferences, such as a language used for closed captioning or subtitles. Preferences may also include whether to use community information from the crowd-sourced content database 106, whether to share information with the crowd-sourced content database 106, whether to enable or disable the media processing of the media processor 100, and other preferences to control operation and configuration of the media processor 102.

An anonymous user profile may be generated and maintained by the user profile database 110. The anonymous user profile may be identified using one or more biometric markers obtained from the user while viewing a presentation. For example, the media player 114 may be equipped with a user-facing camera, which may be used to obtain a facial signature of the user's face. As another example, the media player 114 may be equipped with a microphone to capture one or more voice samples of the user and generate a voice signature of the user. Other non-invasive biometric markers may be used, such as the user's height, body morphology, skin tone, hair color, and the like. Semi-invasive biometric markers may also be obtained through user interaction. Semi-invasive biometric markers include data like fingerprints, retinal scans, or the like. To gather such data, the user may have to actively interact with the media player 114 or other auxiliary device (e.g., a fingerprint scanner) to provide the biometric marker.

In another aspect, an anonymous user profile may be implemented using an arbitrary username or profile name, which may be provided by the user. As such, the user's identity is substantially concealed while at the same time, a unique user profile is generated and maintained.

The user profile database 110 may be any type of data storage facility including, but not limited to a flat file database, a relational database, or the like. The user profile database 110 may be stored at the media processor 102, media. player 114, or separate from other components of the system illustrated in FIG. 1.

The content analyzer 104 is used to analyze media content 112. The content analyzer 104 may be used as a pre-processor to analyze media content and tag the media content 112 with metadata. The metadata may be used to bookmark portions of the media content 112 where dialog may be difficult to understand, where scenes may be difficult to see, or the like. The content analyzer 104 may analyze a voice track of the media content 112 to determine where words or phrases are slurred, mumbled, or otherwise difficult to comprehend, and may obtain or create captioning or subtitling for the words or phrases. The captions or subtitles may then be stored with the media content 112 for use in certain situations.

In another embodiment, the content analyzer 104 may analyze the media content 112 and flag or bookmark certain portions as being potentially difficult to hear or see. The media content 112 may be processed in a separate process to add captions or subtitles. As such, when the media player 114 plays the media content 112, the media player 114 may conditionally access the captions or subtitles and display them contemporaneously with the corresponding video and audio.

In another aspect, the content analyzer 104 is used to analyze and tag the media content 112 with metadata to mark sound volumes, spoken word frequencies, haptic output setting levels, locations of visual elements relative to the user visual field, language, accent of a speaker, crowd-sourced information about scenes, etc. This includes analysis of audio and video for volume and tones in language, brightness and contrast in video, and object and character tracking. The content analyzer 104 may determine which character or person is talking in the media content 112 and mark this in the media content 112. Some or all of this type of information is then used by the media processor 102 to adjust aspects of the presentation.

The crowd-sourced content database 106 includes user experience data from a plurality of users. The crowd-sourced content database 106 may be automatically populated from actions taken by a user at a local or remote system. For example, when the user viewing the media content 112 repeated rewinds and replays a portion of the media content 112, the inference is that the user may have had difficulty understand one or more aspects of the portion. The user/viewer may have had difficulty understanding the dialog because of a thick accent, because of use of a foreign language phrase, or due to mumbling or other language characteristics. The viewer may have had difficulty seeing the actors in a scene due to poor lighting, as another example. By tracking the consumption characteristics of several users, the crowd-sourced content database 106 is used to provide insight into certain portions of the media content 112 as being difficult to understand for various reasons.

Thus, with crowd-sourced data, the system 100 illustrated in FIG. 1 is able to track which media segments tend to need some sort of compensation, either through audio adjustments or video adjustments. The system 100 may cross-reference crowd-source data with the user's profile (e.g., that stored in the user profile database 110) and anticipate a given user's need for compensation (e.g., closed captioning) in some or all of the playback. In an embodiment, the crowd-sourced data includes the number of times and amount that a user has rewound a portion of the media content 112. The number of times may be averaged or otherwise mathematically adjusted across all of the users in the crowd-sourced data. The amount that is rewound may be averaged or otherwise mathematically adjusted across the users in the crowd-sourced data.

For example, if the current user is a 45 year old male, then the crowd-sourced data may be conditioned in a way to adjust for the current user's demographic profile. Weighted functions that weight users from the crowd-sourced data higher who are closer to the current user in various aspects may be used to modify and personalize the media processing for the current user. As an example, if a 43 year old male rewound a portion of the media content 112 four times, then the four count may be weighed higher than if a 74 year old female rewound the same portion seven times. Thus a weighted average of five time may be used in further calculations.

Using crowd-sourced data and other information, the media processor 100 is able to conditionally and preemptively adjust various aspects of the playback of the media content 112 for the current user.

The context of the playback may also be captured in the crowd-source data and compared to the current user's environment. Context includes variables such as the amount of ambient light available, the time of day, the media player's settings (e.g., volume, brightness, contrast, etc.), the amount of ambient noise, etc., that was existent at the time of playback for the users corresponding to the crowd-sourced data.

The media player 114, also referred to as a media playback device, may be a set-top box, a Blu-ray player, a DVD player, or another auxiliary device, which when connected to a display device (not shown), is used to present the media content 112. Alternatively, the media player 114 may be incorporated with the display device, such as may be the case with a laptop computer with an integrated DVD drive. The media player 114 may include ports, connections, radios, or other mechanism to communicatively connect with display devices, remote controls, audio-visual components in a home theater system, or the like, illustrated in FIG. 1 as an audio/visual output 120. The media player 114 may include an operating system 122 to interface with the A/V out 120 port or controller 118 via hardware abstraction layers, and an application space 124 to execute user-level applications. Other conventional aspects of the media player 114 are omitted to reduce the complexity of FIG. 1, but are understood to be within the scope of this disclosure.

The media player 114 may receive media enhancement control parameters 116 from a user (viewer). The media enhancement control parameters 116 may be in the form of traditional control parameters, such as when the user increases or decreases volume, uses a rewind or fast-forward control to alter playback, or changes the display properties (e.g., increasing/decreasing brightness controls). The media enhancement control parameters 116 may also be obtained passively or actively from the user by observing user behavior or asking the user about the viewing experience. In an embodiment, the media enhancement control parameters 116 are received at a controller 118, which may be integrated into the media player 114, such as on a front panel of the media player 114 (e.g., volume knob, play/pause/rewind buttons, etc.). The controller 118 may be communicatively coupled with a receiver, such as an infrared receiver, that receives signals transmitted by the user. For example, the receiver may be an infrared receiver for use with a remote control operated by the user.

The media processor 102 may use the media enhancement control parameters 116 to determine whether or which media adjustments to apply to the media content 112. Additionally, the media processor 100 may report the media enhancement control parameters 116 used to the crowd-sourced content database 106 to add to the repository of crowd-sourced data for use at other media playback systems. The media processor 102 may also report the media enhancement control parameters 116 to the user profile database 110 indicating how the user altered playback settings for the current viewing.

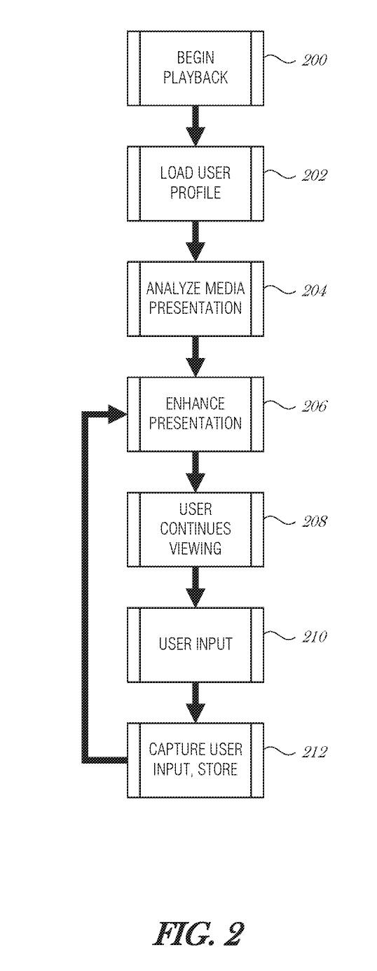

FIG. 2 is a schematic diagram illustrating data and control flow, according to an embodiment. A user accesses an audio-visual presentation, such as a movie, and begins playback (stage 200). The media playback device obtains a user profile of the user, if it exists, and loads it into memory (stage 202). The media playback device may operate in conjunction with a media processor, such as that described in FIG. 1. The media playback device may stream content over a network, where the streamed content may be modified by an offsite media processor. Alternatively, the media processor may be incorporated into the media playback device and co-located with the user. Other configurations of the media playback device and the media processor are understood to be within the scope of this disclosure.

As the media presentation is played, the media processor may alone, or with the assistance of other co-processors such as a content analyzer processor, analyze the media presentation for metadata, such as tags, headers, or other information describing aspects of the media presentation (stage 204). The metadata may include information such as the language of the dialog, the actors in the movie, quiet and loud portions of the dialog or soundtrack, lighting and effects used in scenes presented in the media presentation, and the like. The metadata may also include a track for closed captioning or subtitles.

During playback, the media playback device enhances the audio-video presentation based on the user profile, environmental viewing conditions, crowd-sourced data, user feedback, and other input (stage 206).

As an operating example, the media playback device may automatically adjust the volume of quiet scenes to a minimum threshold volume when the user is known to have a hearing deficiency.

As another operating example, the media playback device may automatically add subtitles or captioning when the dialog is muddled, quiet, or otherwise difficult to understand. The subtitles or captioning may be temporary, for example, during a certain scene or for a certain actor with a heavy accent.

As another operating example, scenes may be brightened or lightened, for example by changing a gamma setting of the media playback device, so that a user with a vision deficiency is able to ascertain movement in a scene.

As another operating example, portions of the audio-visual presentation that have been rewound by others as indicated by crowd-source data may be automatically augmented with captioning or subtitling during playback for the current user.

As another operating example, the user may rewind the current playback, such as by using a 10-second rewind function button on a remote control. In response, the media playback device may present captions or subtitles for the rewound portion, and then disable captions/subtitles after the rewound portion has been replayed.

At stage 208, the user continues viewing the audio-visual presentation, during which the user may use various media enhancement controls (stage 210). Media enhancement controls include operations, functions, or modes such as increasing or decreasing volume, rewinding or fast-forwarding playback, reducing playback speed, increasing brightness or contrast of the display device, altering color schemes used in the presentation, or the like. The media enhancements, along with other optional information, may be captured in the user profile or elsewhere, such as the crowd-source database (stage 212). Optional information may include contextual data, such as the time of playback, ambient noise during playback, ambient light during playback, etc.

Based on the user input received at stage 210, the media playback device may further enhance the presentation. Processing may iterate based on further user input into the system.

In an embodiment, the user may select a character in a presentation, such as a particular actor, newscaster, or the like, and in response to the selection, the audio-visual presentation may be augmented with captioning or subtitles for the selected character. The captions or subtitles may be obtained from metadata associated with the audio-visual presentation.

In another embodiment, the user may select a character in a presentation and the character's audio track may be replaced with a dubbed track. In this manner, the character's spoken lines may be more easily understood by the user. The dubbed track may be in a different language, accent, or have other sound qualities (e.g., louder, more enunciated, etc.) that allow users to understand the speech audio better.

In another embodiment, the user may activate a user interface control (e.g., a button on a remote control, a command key shortcut, etc.) to replay a portion of the audio-visual presentation with enhancements. In a related embodiment, the replayed portion may include lyrics of a song, either spoken clearly or with subtitles. In another related embodiment, the replayed portion may include subtitles or captions of dialog or other speech audio. In another related embodiment, the replayed portion may be brightened or otherwise have its video attributes altered for easier viewing. The media enhancements may be temporary and last for only as long as the replayed portion. Alternatively, the media enhancements may be active until turned off by the user or until the media presentation ends. As another alternative, the media enhancements may continue until a change in the immediate environment around the user. For example, when ambient noise decreases by more than half of the initial level measured at the time of the start of playback, then the subtitles may be deactivated.

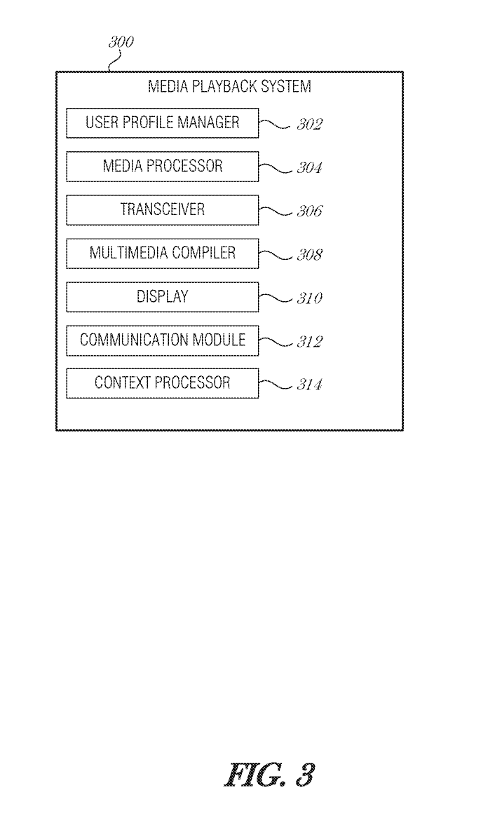

FIG. 3 is a block diagram illustrating a system 300 for adjusting media playback, according to an embodiment. The system 300 includes a user profile manager 302, a media processor 304, a transceiver 306, a multimedia compiler 308, a display 310, and an optional communication module 312 and context processor 314.

The user profile manager 302, media processor 304, transceiver 306, multimedia compiler 308, communication module 312, and context processor 314 are understood to encompass tangible entities that are physically constructed, specifically configured (e.g., hardwired), or temporarily (e.g., transitorily) configured (e.g., programmed) to operate in a specified manner or to perform part or all of any operations described herein. Such tangible entitles may be constructed using one or more circuits, such as with dedicated hardware (e.g., field programmable gate arrays (FPGAs), logic gates, graphics processing unit (GPU), a digital signal processor (DSP), etc.). As such, the tangible entities described herein may be referred to as circuits, circuitry, processor units, or the like.

The user profile manager 302 may be configured, programmed, or otherwise constructed to access a user profile database to obtain a user profile associated with a user of the media playback system, the media playback system to present a media presentation.

The media processor 304 may be configured, programmed, or otherwise constructed to analyze the media presentation to obtain metadata embedded in the media presentation.

The transceiver 306 may be configured, programmed, or otherwise constructed to receive a media enhancement command at the media playback system. The transceiver 306 may be an infrared transceiver, a Bluetooth transceiver, or other radio, light, or sound-based transceiver capable of receiving a wireless signal from the user. Alternatively, the transceiver 306 may be a manual input on the media playback system, such as a touchscreen, button, rheostat slider or dial, or the like.

The multimedia compiler 308 may be communicatively coupled to the transceiver when in operation, and may be configured, programmed, or otherwise constructed to alter the media presentation in response to the media enhancement command, to produce an altered presentation of the media presentation, the alteration based on the media enhancement command, the metadata, and the user profile.

The display 310 may be communicatively coupled to the multimedia. compiler when in operation, and may be configured, programmed, or otherwise constructed to present the altered presentation to the user on the display. The display 310 may be a liquid-crystal display (LCD), light-emitting diode (LED) display, or the like, and may take on various form factors, such as in a smart phone, television, head-mounted display, projection system, etc.

In an embodiment, the user profile comprises visual impairment information of the user, and to alter the media presentation, the multimedia compiler 308 is to alter the media presentation to accommodate a visual impairment condition corresponding to the visual impairment information of the user.

In an embodiment, the user profile comprises hearing impairment information of the user, and to alter the media presentation, the multimedia compiler 308 is to alter the media presentation to accommodate a hearing impairment condition corresponding to the hearing impairment information of the user.

In an embodiment, the system 300 includes the communication module 312, which may be configured, programmed, or otherwise constructed to access cloud-source data. In such an embodiment, to alter the media presentation, the multimedia compiler 308 is to alter the media presentation based on the cloud-source data.

In an embodiment, the cloud-source data indicates a portion of the media presentation that is frequently replayed, and to alter the media presentation, the multimedia compiler 308 is to include textual dialog for the portion of the media presentation that is frequently replayed.

In an embodiment, the multimedia compiler 308 is to compare the user profile with the cloud-source data to determine a similarity index on an aspect of the cloud-source data, the cloud-source data including correlations between a population of viewers and media adjustments of the media presentation. In such an embodiment, to alter the media presentation, the multimedia compiler 308 is to alter the media presentation when the similarity index exceeds a threshold value. In a further embodiment, the similarity index indicates a similarity between a hearing capability included in the user profile with hearing capability of similar people from the cloud-source data. In another embodiment, to alter the media presentation, the multimedia compiler 308 is to adjust an audio track of the media presentation to accommodate the hearing capability included in the user profile when the similarity index exceeds the threshold value. In various embodiments, the audio track adjustment comprises at least one of: increasing the volume, decreasing the volume, or using a dub track.

In an embodiment, the similarity index indicates a similarity between a vision capability included in the user profile with vision capability of similar people from the cloud-source data. In a further embodiment, to alter the media presentation, the multimedia compiler 308 is to adjust a video portion of the media presentation to accommodate the vision capability included in the user profile when the similarity index exceeds the threshold value. In various embodiments, the video portion adjustment comprises at least one of increasing a brightness setting, decreasing a brightness setting, increasing a contrast setting, decreasing a contrast setting, or using a substitute color palette.

In an embodiment, to receive the media enhancement command at the media playback system, the transceiver 306 is to receive a replay command. In such an embodiment, to alter the media presentation, the multimedia compiler 308 is to include textual dialog for the portion of the media presentation that was replayed via the replay command. In a further embodiment, the replay command comprises a fixed duration rewind-and-play command. In a further embodiment, the fixed duration is substantially 10 seconds.

In an embodiment, the cloud-source data is contained in the metadata. Alternatively, to access the cloud-source data, the communication module 312 is to connect to a cloud-source database and retrieve the cloud-source data from the cloud-source database. The communication module 312 may include various circuits, hardware, antennas, and other components to provide long-distance communication, such over a cellular or Wi-Fi network.

In an embodiment, the media enhancement command comprises a volume adjustment of the media playback system. In a related embodiment, the media enhancement command comprises a rewind command of the media playback system. In another embodiment, the media enhancement command comprises a brightness adjustment of the media playback system.

In an embodiment, the media enhancement command is received from a context processor 314 in the media playback system, the context processor 314 to monitor an environmental variable in a playback environment of the media playback system. The context processor 314 may be communicatively coupled to one or more environmental sensors, biometric sensors, system sensors, or the like to monitor aspects of the playback environment, the user, or the condition or state of the media playback system 300.

In a further embodiment, the environmental variable is ambient noise, and wherein the media enhancement command includes indicating that the ambient noise is louder than a threshold noise level. In a further embodiment, to alter the media presentation, the multimedia compiler 308 is to include textual dialog for the media presentation while the ambient noise is louder than the threshold noise level. In an embodiment, the threshold noise level is personalized to the user.

In an embodiment, the media enhancement command includes an identification of a subject of the media presentation, and to alter the media presentation, the multimedia compiler 308 is to include textual dialog for the media presentation solely for the identified subject.

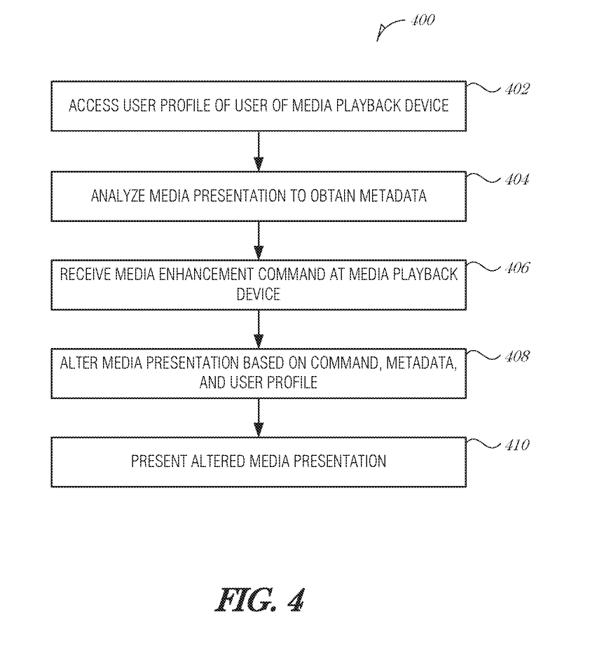

FIG. 4 is a flowchart illustrating a method 400 of adjusting media playback, according to an embodiment. At 402, a user profile database is accessed via a media playback device, to obtain a user profile associated with a user of the media playback device, the media playback device presenting a media presentation.

At 404 the media presentation is analyzed to obtain metadata embedded in the media presentation.

At 406, a media enhancement command is received at the media playback device.

At 408, the media presentation is altered in response to the media enhancement command to produce an altered presentation of the media presentation, the alteration based on the media enhancement command, the metadata, and the user profile. In an embodiment, the user profile includes visual impairment information of the user, and altering the media presentation includes altering the media presentation to accommodate a visual impairment condition corresponding to the visual impairment information of the user.

In an embodiment, the user profile includes hearing impairment information of the user, and altering the media presentation includes altering the media presentation to accommodate a hearing impairment condition corresponding to the hearing impairment information of the user.

At 410, the altered presentation is presented, via the media playback device, to the user. The presentation may be on a computer monitor, a television, in a head-mounted display, with a projection system, or with any other type of presentation device or mechanism.

In an embodiment, the method 400 includes accessing cloud-source data, and in such an embodiment, altering the media presentation includes altering the media presentation based on the cloud-source data. The cloud-source data may be a population of people who have watched the same media presentation or a similar media presentation. In a further embodiment, the cloud-source data indicates a portion of the media presentation that is frequently replayed, and in such an embodiment, altering the media presentation includes including textual dialog for the portion of the media presentation that is frequently replayed.

In a related embodiment, the method 400 includes comparing the user profile with the cloud-source data to determine a similarity index on an aspect of the cloud-source data, the cloud-source data comprising correlations between a population of viewers and media adjustments of the media presentation. In such an embodiment, altering the media presentation comprises altering the media presentation when the similarity index exceeds a threshold value. The similarity index may be a percentage indicating how similar the user is to a subset of the population represented in the cloud-source data. In an embodiment, the similarity index indicates a similarity between a hearing capability included in the user profile with hearing capability of similar people from the cloud-source data. In a further embodiment, altering the media presentation includes adjusting an audio track of the media presentation to accommodate the hearing capability included in the user profile when the similarity index exceeds the threshold value. For example, if the user's hearing is 96% similar to those in the cloud-source data that have increased the volume for a portion of the media presentation, then the volume of the media playback device may be increased for the same portion. In various embodiments, adjusting the audio track comprises at least one of increasing the volume, decreasing the volume, or using a dub track.

In an embodiment, the similarity index indicates a similarity between a vision capability included in the user profile with vision capability of similar people from the cloud-source data. In a further embodiment, altering the media presentation comprises adjusting a video portion of the media presentation to accommodate the vision capability included in the user profile when the similarity index exceeds the threshold value. In various embodiments, adjusting the video portion comprises at least one of increasing a brightness setting, decreasing a brightness setting, increasing a contrast setting, decreasing a contrast setting, or using a substitute color palette.

In an embodiment, receiving the media enhancement command at the media playback device comprises receiving a replay command. In such an embodiment, altering the media presentation comprises including textual dialog for the portion of the media presentation that was replayed via the replay command. In a further embodiment, the replay command comprises a fixed duration rewind-and-play command. For example, the user may have a 10-second rewind button on a remote control, which when activated rewinds the playback of the media presentation by 10 seconds. Thus, in an embodiment, the fixed duration is substantially 10 seconds.

In an embodiment, the cloud-source data is contained in the metadata. Alternatively, in an embodiment, accessing the cloud-source data comprises connecting to a cloud-source database and retrieving the cloud-source data from the cloud-source database.

In an embodiment, the media enhancement command comprises a volume adjustment of the media playback device. In a related embodiment, the media enhancement command comprises a rewind command of the media playback device. In another embodiment, the media enhancement command comprises a brightness adjustment of the media playback device.

In an embodiment, the media enhancement command is received from a context processor in the media playback device, the context processor to monitor an environmental variable in a playback environment of the media playback device. The context processor may implement or interface with one or more environmental, biometric, or other sensors to monitor the user, the playback environment, the status or condition of the media playback device, or other aspects of the surroundings.

In an embodiment, the environmental variable is ambient noise, and wherein the media enhancement command includes indicating that the ambient noise is louder than a threshold noise level. In a further embodiment, altering the media presentation comprises including textual dialog for the media presentation while the ambient noise is louder than the threshold noise level. In a further embodiment, the threshold noise level is personalized to the user. For example, the threshold noise level may be based on a simple hearing test administered to the user. Alternatively, the threshold noise level may be inferred or determined by comparing the user to the crowd-source data.

In an embodiment, the media enhancement command includes an identification of a subject of the media presentation, and in such an embodiment, altering the media presentation comprises including textual dialog for the media presentation solely for the identified subject. In this manner, an actor, for example, who has a particular accent or speaks softly may be augmented with subtitles to allow the user to follow the dialog easier.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, circuits, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

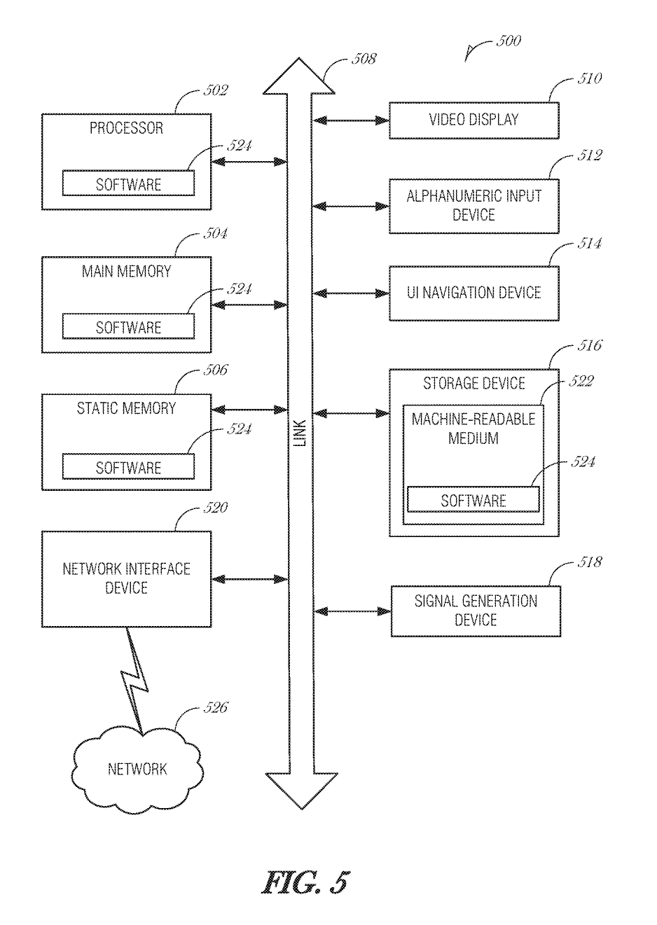

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, gyrometer, magnetometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 includes subject matter for adjusting media playback (such as a device, apparatus, or machine) comprising a media playback system comprising: a user profile manager to access a user profile database to obtain a user profile associated with a user of the media playback system, the media playback system to present a media presentation; a media processor to analyze the media presentation to obtain metadata embedded in the media presentation; a transceiver to receive a media enhancement command at the media playback system; a multimedia compiler communicatively coupled to the transceiver when in operation, to alter the media presentation in response to the media enhancement command, to produce an altered presentation of the media presentation, the alteration based on the media enhancement command, the metadata, and the user profile; and a display communicatively coupled to the multimedia compiler when in operation, to present the altered presentation to the user on the display.

In Example 2, the subject matter of Example 1 may include, wherein the user profile comprises visual impairment information of the user, and wherein to alter the media presentation, the multimedia compiler is to alter the media presentation to accommodate a visual impairment condition corresponding to the visual impairment information of the user.

In Example 3, the subject matter of any one of Examples 1 to 2 may include, wherein the user profile comprises hearing impairment information of the user, and wherein to alter the media presentation, the multimedia compiler is to alter the media presentation to accommodate a hearing impairment condition corresponding to the hearing impairment information of the user.

In Example 4, the subject matter of any one of Examples 1 to 3 may include, a communication module to access cloud-source data, and wherein to alter the media presentation, the multimedia compiler is to alter the media presentation based on the cloud-source data.

In Example 5, the subject matter of any one of Examples 1 to 4 may include, wherein the cloud-source data indicates a portion of the media presentation that is frequently replayed, and wherein to alter the media presentation, the multimedia compiler is to include textual dialog for the portion of the media presentation that is frequently replayed.

In Example 6, the subject matter of any one of Examples 1 to 5 may include, wherein the multimedia compiler is to compare the user profile with the cloud-source data to determine a similarity index on an aspect of the cloud-source data, the cloud-source data correlations between a population of viewers and media adjustments of the media presentation; and wherein to alter the media presentation, the multimedia compiler is to alter the media presentation when the similarity index exceeds a threshold value.

In Example 7, the subject matter of any one of Examples 1 to 6 may include, wherein the similarity index indicates a similarity between a hearing capability included in the user profile with hearing capability of similar people from the cloud-source data.

In Example 8, the subject matter of any one of Examples 1 to 7 may include, wherein to alter the media presentation, the multimedia compiler is to adjust an audio track of the media presentation to accommodate the hearing capability included in the user profile when the similarity index exceeds the threshold value.

In Example 9, the subject matter of any one of Examples 1 to 8 may include, wherein the audio track adjustment comprises at least one of: increasing the volume, decreasing the volume, or using a dub track.

In Example 10, the subject matter of any one of Examples 1 to 9 may include, wherein the similarity index indicates a similarity between a vision capability included in the user profile with vision capability of similar people from the cloud-source data.

In Example 11, the subject matter of any one of Examples 1 to 10 may include, wherein to alter the media presentation, the multimedia compiler is to adjust a video portion of the media presentation to accommodate the vision capability included in the user profile when the similarity index exceeds the threshold value.

In Example 12, the subject matter of any one of Examples 1 to 11 may include, wherein the video portion adjustment comprises at least one of: increasing a brightness setting, decreasing a brightness setting, increasing a contrast setting, decreasing a contrast setting, or using a substitute color palette.

In Example 13, the subject matter of any one of Examples 1 to 12 may include, wherein to receive the media enhancement command at the media playback system, the transceiver is to receive a replay command; and wherein to alter the media presentation, the multimedia compiler is to include textual dialog for the portion of the media presentation that was replayed via the replay command.

In Example 14, the subject matter of any one of Examples 1 to 13 may include, wherein the replay command comprises a fixed duration rewind-and-play command.

In Example 15, the subject matter of any one of Examples 1 to 14 may include, wherein the fixed duration is substantially 10 seconds.

In Example 16, the subject matter of any one of Examples 1 to 15 may include, wherein the metadata includes cloud-source data.

In Example 17, the subject matter of any one of Examples 1 to 16 may include, wherein the media enhancement command comprises a volume adjustment of the media playback system.

In Example 18, the subject matter of any one of Examples 1 to 17 may include, wherein the media enhancement command comprises a rewind command of the media playback system.

In Example 19, the subject matter of any one of Examples 1 to 18 may include, wherein the media enhancement command comprises a brightness adjustment of the media playback system.

In Example 20, the subject matter of any one of Examples 1 to 19 may include, wherein the media enhancement command is received from a context processor in the media playback system, the context processor to monitor an environmental variable in a playback environment of the media playback system.

In Example 21, the subject matter of any one of Examples 1 to 20 may include, wherein the environmental variable is ambient noise, and wherein the media enhancement command includes indicating that the ambient noise is louder than a threshold noise level.

In Example 22, the subject matter of any one of Examples 1 to 21 may include, wherein to alter the media presentation, the multimedia compiler is to include textual dialog for the media presentation while the ambient noise is louder than the threshold noise level.

In Example 23, the subject matter of any one of Examples 1 to 22 may include, wherein the threshold noise level is personalized to the user.

In Example 24, the subject matter of any one of Examples 1 to 23 may include, wherein the media enhancement command includes an identification of a subject of the media presentation, and wherein to alter the media presentation, the multimedia compiler is to include textual dialog for the media presentation solely for the identified subject.

Example 25 includes subject matter for adjusting media playback (such as a method, means for performing acts, machine readable medium including instructions that when performed by a machine cause the machine to performs acts, or an apparatus to perform) comprising: accessing, via a media playback device, a user profile database to obtain a user profile associated with a user of the media playback device, the media playback device presenting a media presentation; analyzing the media presentation to obtain metadata embedded in the media presentation; receiving a media enhancement command at the media playback device; altering the media presentation in response to the media enhancement command, the alteration based on the media enhancement command, the metadata, and the user profile to produce an altered presentation of the media presentation; and presenting, via the media playback device, the altered presentation to the user.

In Example 26, the subject matter of Example 25 may include, wherein the user profile comprises visual impairment information of the user, and wherein altering the media presentation comprises altering the media presentation to accommodate a visual impairment condition corresponding to the visual impairment information of the user.

In Example 27, the subject matter of any one of Examples 25 to 26 may include, wherein the user profile comprises hearing impairment information of the user, and wherein altering the media presentation comprises altering the media presentation to accommodate a hearing impairment condition corresponding to the hearing impairment information of the user.

In Example 28, the subject matter of any one of Examples 25 to 27 may include, accessing cloud-source data, and wherein altering the media presentation comprises altering the media presentation based on the cloud-source data.

In Example 29, the subject matter of any one of Examples 25 to 28 may include, wherein the cloud-source data indicates a portion of the media presentation that is frequently replayed, and wherein altering the media presentation comprises textual dialog for the portion of the media presentation that is frequently replayed.

In Example 30, the subject matter of any one of Examples 25 to 29 may include, comparing the user profile with the cloud-source data to determine a similarity index on an aspect of the cloud-source data, the cloud-source data correlations between a population of viewers and media adjustments of the media presentation; and wherein altering the media presentation comprises altering the media presentation when the similarity index exceeds a threshold value.

In Example 31, the subject matter of any one of Examples 25 to 30 may include, wherein the similarity index indicates a similarity between a hearing capability included in the user profile with hearing capability of similar people from the cloud-source data.

In Example 32, the subject matter of any one of Examples 25 to 31 may include, wherein altering the media presentation comprises adjusting an audio track of the media presentation to accommodate the hearing capability included in the user profile when the similarity index exceeds the threshold value,

In Example 33, the subject matter of any one of Examples 25 to 32 may include, wherein adjusting the audio track comprises at least one of: increasing the volume, decreasing the volume, or using a dub track.

In Example 34, the subject matter of any one of Examples 25 to 33 may include, wherein the similarity index indicates a similarity between a vision capability included in the user profile with vision capability of similar people from the cloud-source data.

In Example 35, the subject matter of any one of Examples 25 to 34 may include, wherein altering the media presentation comprises adjusting a video portion of the media presentation to accommodate the vision capability included in the user profile when the similarity index exceeds the threshold value.

In Example 36, the subject matter of any one of Examples 25 to 35 may include, wherein adjusting the video portion comprises at least one of: increasing a brightness setting, decreasing a brightness setting, increasing a contrast setting, decreasing a contrast setting, or using a substitute color palette.

In Example 37, the subject matter of any one of Examples 25 to 36 may include, wherein receiving the media enhancement command at the media playback device comprises receiving a replay command; and wherein altering the media presentation comprises including textual dialog for the portion of the media presentation that was replayed via the replay command.

In Example 38, the subject matter of any one of Examples 25 to 37 may include, wherein the replay command comprises a fixed duration rewind-and-play command.

In Example 39, the subject matter of any one of Examples 25 to 38 may include, wherein the fixed duration is substantially 10 seconds.

In Example 40, the subject matter of any one of Examples 25 to 39 may include, wherein the metadata includes cloud-source data.

In Example 41, the subject matter of any one of Examples 25 to 40 may include, wherein the media enhancement command comprises a volume adjustment of the media playback device.

In Example 42, the subject matter of any one of Examples 25 to 41 may include, wherein the media enhancement command comprises a rewind command of the media playback device.

In Example 43, the subject matter of any one of Examples 25 to 42 may include, wherein the media enhancement command comprises a brightness adjustment of the media playback device

In Example 44, the subject matter of any one of Examples 25 to 43 may include, wherein the media enhancement command is received from a context processor in the media playback device, the context processor to monitor an environmental variable in a playback environment of the media playback device.

In Example 45, the subject matter of any one of Examples 25 to 44 may include, wherein the environmental variable is ambient noise, and wherein the media enhancement command includes indicating that the ambient noise is louder than a threshold noise level.

In Example 46, the subject matter of any one of Examples 25 to 45 may include, wherein altering the media presentation comprises textual dialog for the media presentation while the ambient noise is louder than the threshold noise level.

In Example 47, the subject matter of any one of Examples 25 to 46 may include, wherein the threshold noise level is personalized to the user.

In Example 48, the subject matter of any one of Examples 25 to 47 may include, wherein the media enhancement command includes an identification of a subject of the media presentation, and wherein altering the media presentation comprises textual dialog for the media presentation solely for the identified subject.

Example 49 includes at least one machine-readable medium including instructions, which when executed by a machine, cause the machine to perform operations of any of the Examples 25-48.

Example 50 includes an apparatus comprising means for performing any of the Examples 25-48.

Example 51 includes subject matter for adjusting media playback (such as a device, apparatus, or machine) comprising: means for accessing, via a media playback device, a user profile database to obtain a user profile associated with a user of the media playback device, the media playback device presenting a media presentation; means for analyzing the media presentation to obtain metadata embedded in the media presentation; means for receiving a media enhancement command at the media playback device; means for altering the media presentation in response to the media enhancement command, the alteration based on the media enhancement command, the metadata, and the user profile to produce an altered presentation of the media presentation; and means for presenting, via the media playback device, the altered presentation to the user.

In Example 52, the subject matter of Example 51 may include, wherein the user profile comprises visual impairment information of the user, and wherein the means for altering the media presentation comprise means for altering the media presentation to accommodate a visual impairment condition corresponding to the visual impairment information of the user.

In Example 53, the subject matter of any one of Examples 51 to 52 may include, wherein the user profile comprises hearing impairment information of the user, and wherein the means for altering the media presentation comprise means for altering the media presentation to accommodate a hearing impairment condition corresponding to the hearing impairment information of the user.

In Example 54, the subject matter of any one of Examples 51 to 53 may include, means for accessing cloud-source data, and wherein altering the media presentation comprises altering the media presentation based on the cloud-source data.

In Example 55, the subject matter of any one of Examples 51 to 54 may include, wherein the cloud-source data indicates a portion of the media presentation that is frequently replayed, and wherein the means for altering the media presentation comprise means for textual dialog for the portion of the media presentation that is frequently replayed.

In Example 56, the subject matter of any one of Examples 51 to 55 may include, means for comparing the user profile with the cloud-source data to determine a similarity index on an aspect of the cloud-source data, the cloud-source data correlations between a population of viewers and media adjustments of the media presentation; and wherein the means for altering the media presentation comprise means for altering the media presentation when the similarity index exceeds a threshold value.

In Example 57, the subject matter of any one of Examples 51 to 56 may include, wherein the similarity index indicates a similarity between a hearing capability included in the user profile with hearing capability of similar people from the cloud-source data.

In Example 58, the subject matter of any one of Examples 51 to 57 may include, wherein the means for altering the media presentation comprise means for adjusting an audio track of the media presentation to accommodate the hearing capability included in the user profile when the similarity index exceeds the threshold value.

In Example 59, the subject matter of any one of Examples 51 to 58 may include, wherein adjusting the audio track comprises at least one of: increasing the volume, decreasing the volume, or using a dub track.

In Example 60, the subject matter of any one of Examples 51 to 59 may include, wherein the similarity index indicates a similarity between a vision capability included in the user profile with vision capability of similar people from the cloud-source data.

In Example 61, the subject matter of any one of Examples 51 to 60 may include, wherein the means for altering the media presentation comprise means for adjusting a video portion of the media presentation to accommodate the vision capability included in the user profile when the similarity index exceeds the threshold value.

In Example 62, the subject matter of any one of Examples 51 to 61 may include, wherein adjusting the video portion comprises at least one of: increasing a brightness setting, decreasing a brightness setting, increasing a contrast setting, decreasing a contrast setting, or using a substitute color palette.

In Example 63, the subject matter of any one of Examples 51 to 62 may include, wherein the means for receiving the media enhancement command at the media playback device comprise means for receiving a replay command; and wherein the means for altering the media presentation comprise means for textual dialog for the portion of the media presentation that was replayed via the replay command.

In Example 64, the subject matter of any one of Examples 51 to 63 may include, wherein the replay command comprises a fixed duration rewind-and-play command.

In Example 65, the subject matter of any one of Examples 51 to 64 may include, wherein the fixed duration is substantially 10 seconds.

In Example 66, the subject matter of any one of Examples 51 to 65 may include, wherein the metadata includes cloud-source data.

In Example 67, the subject matter of any one of Examples 51 to 66 may include, wherein the media enhancement command comprises a volume adjustment of the media playback device.

In Example 68, the subject matter of any one of Examples 51 to 67 may include, wherein the media enhancement command comprises a rewind command of the media playback device.

In Example 69, the subject matter of any one of Examples 51 to 68 may include, wherein the media enhancement command comprises a brightness adjustment of the media playback device.

In Example 70, the subject matter of any one of Examples 51 to 69 may include, wherein the media enhancement command is received from a context processor in the media playback device, the context processor to monitor an environmental variable in a playback environment of the media playback device.

In Example 71, the subject matter of any one of Examples 51 to 70 may include, wherein the environmental variable is ambient noise, and wherein the media enhancement command includes indicating that the ambient noise is louder than a threshold noise level.

In Example 72, the subject matter of any one of Examples 51 to 71 may include, wherein the means for altering the media presentation comprise means for textual dialog for the media presentation while the ambient noise is louder than the threshold noise level.

In Example 73, the subject matter of any one of Examples 51 to 72 may include, wherein the threshold noise level is personalized to the user.

In Example 74, the subject matter of any one of Examples 51 to 73 may include, wherein the media enhancement command includes an identification of a subject of the media presentation, and wherein the means for altering the media presentation comprise means for textual dialog for the media presentation solely for the identified subject.

The above detailed description includes references to the accompanying drawings, which form a part of the detailed description. The drawings show, by way of illustration, specific embodiments that may be practiced. These embodiments are also referred to herein as “examples,” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated references) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A media playback system for adjusting media playback, the media playback system comprising:
a user profile manager to access a user profile database to obtain a user profile associated with a user of the media playback system, the media playback system to present a media presentation;
a media processor to analyze the media presentation to obtain metadata embedded in the media presentation;
a transceiver to receive a media enhancement command at the media playback system;
a multimedia compiler communicatively coupled to the transceiver when in operation, to alter the media presentation in response to the media enhancement command, to transform the media presentation to produce an altered presentation of the media presentation, the alteration based on the media enhancement command, the metadata, and the user profile;
a display communicatively coupled to the multimedia compiler when in operation, to present the altered presentation to the user on the display; and
a communication module to access cloud-source data, the cloud-sourced data including data from viewers who have viewed the media presentation, the multimedia compiler to compare the user profile with the cloud-source data to determine a similarity index on an aspect of the cloud-source data, the cloud-source data including correlations between a population of viewers of the media presentation and media adjustments of the media presentation made during viewing the media presentation by the population of viewers, the similarity index being a percentage indicating how similar the user is to a subset of the population represented in the cloud-source data;
wherein to alter the media presentation, the multimedia compiler is to alter the media presentation based on the cloud-source data, including altering the media presentation when the similarity index exceeds a threshold value.

2. The system of claim 1, wherein the user profile comprises visual impairment information of the user, and wherein to alter the media presentation, the multimedia compiler is to alter the media presentation to accommodate a visual impairment condition corresponding to the visual impairment information of the user.

3. The system of claim 1, wherein the user profile comprises hearing impairment information of the user, and wherein to alter the media presentation, the multimedia compiler is to alter the media presentation to accommodate a hearing impairment condition corresponding to the hearing impairment information of the user.

4. (canceled)

5. The system of claim 1, wherein the cloud-source data indicates a portion of the media presentation that is frequently replayed, and wherein to alter the media presentation, the multimedia compiler is to include textual dialog for the portion of the media presentation that is frequently replayed.

6. (canceled)

7. The system of claim 1, wherein the similarity index indicates a similarity between a hearing capability included in the user profile with hearing capability of similar people from the cloud-source data.

8. The system of claim 7, wherein to alter the media presentation, the multimedia compiler is to adjust an audio track of the media presentation to accommodate the hearing capability included in the user profile when the similarity index exceeds the threshold value.

9. The system of claim 1, wherein the similarity index indicates a similarity between a vision capability included in the user profile with vision capability of similar people from the cloud-source data.

10. The system of claim 9, wherein to alter the media presentation, the multimedia compiler is to adjust a video portion of the media presentation to accommodate the vision capability included in the user profile when the similarity index exceeds the threshold value.

11. A method of adjusting media playback, the method comprising:
accessing, via a media playback device, a user profile database to obtain a user profile associated with a user of the media playback device, the media playback device presenting a media presentation;
analyzing the media presentation to obtain metadata embedded in the media presentation;
receiving a media enhancement command at the media playback device;
accessing cloud-source data, the cloud-sourced data including data from viewers who have viewed the media presentation;
comparing the user profile with the cloud-source data to determine a similarity index on an aspect of the cloud-source data, the cloud-source data including correlations between a population of viewers of the media presentation and media adjustments of the media presentation made during viewing the media presentation by the population of viewers, the similarity index being a percentage indicating how similar the user is to a subset of the population represented in the cloud-source data;
altering the media presentation in response to the media enhancement command, the alteration based on the media enhancement command, the metadata, the user profile to produce an altered presentation of the media presentation, and the cloud-source data; and
presenting, via the media playback device, the altered presentation to the user.

12. The method of claim 11, wherein the user profile comprises visual impairment information of the user, and wherein altering the media presentation comprises altering the media presentation to accommodate a visual impairment condition corresponding to the visual impairment information of the user.

13. The method of claim 11, wherein the user profile comprises hearing impairment information of the user, and wherein altering the media presentation comprises altering the media presentation to accommodate a hearing impairment condition corresponding to the hearing impairment information of the user.

14. (canceled)

15. The method of claim 11, wherein the cloud-source data indicates a portion of the media presentation that is frequently replayed, and wherein altering the media presentation comprises including textual dialog for the portion of the media presentation that is frequently replayed.

16. The method of claim 11, wherein the media enhancement command is received from a context processor in the media playback device, the context processor to monitor an environmental variable in a playback environment of the media playback device.

17. The method of claim 16, wherein the environmental variable is ambient noise, and wherein the media enhancement command includes indicating that the ambient noise is louder than a threshold noise level.

18. The method of claim 17, wherein altering the media presentation comprises including textual dialog for the media presentation while the ambient noise is louder than the threshold noise level.

19. The method of claim 17, wherein the threshold noise level is personalized to the user.

20. The method of claim 11, wherein the media enhancement command includes an identification of a subject of the media presentation, and wherein altering the media presentation comprises including textual dialog for the media presentation solely for the identified subject.

21. At least one non-transitory machine-readable medium including instructions for adjusting media playback, which when executed by a machine, cause the machine to:
access, via a media playback device, a user profile database to obtain a user profile associated with a user of the media playback device, the media playback device presenting a media presentation;
analyze the media presentation to obtain metadata embedded in the media presentation;
receive a media enhancement command at the media playback device;
access cloud-source data, the cloud-sourced data including data from viewers who have viewed the media presentation;
compare the user profile with the cloud-source data to determine a similarity index on an aspect of the cloud-source data, the cloud-source data including correlations between a population of viewers of the media presentation and media adjustments of the media presentation made during viewing the media presentation by the population of viewers, the similarity index being a percentage indicating how similar the user is to a subset of the population represented in the cloud-source data;
alter the media presentation in response to the media enhancement command, the alteration based on the media enhancement command, the metadata, the user profile to produce an altered presentation of the media presentation, and the cloud-source data; and
present, via the media playback device, the altered presentation to the user.

22. (canceled)

23. The non-transitory machine-readable medium of claim 21, wherein the cloud-source data indicates a portion of the media presentation that is frequently replayed, and wherein the instructions to alter the media presentation comprise instructions to include textual dialog for the portion of the media presentation that is frequently replayed.

24. (canceled)

25. The non-transitory machine-readable medium of claim 21, wherein the media enhancement command is received from a context processor in the media playback device, the context processor to monitor an environmental variable in a playback environment of the media playback device.
